(19) United States
(12) Patent Application Publication
(10) Pub. No.: US 2012/0242085 A1
(43) Pub. Date: Sep. 27, 2012

(54) Motor Yaw Drive System for a Wind Turbine

(75) Inventors: Mark Garfinkel, Goleta, CA (US); Kevin L. Cousineau, Ridgecrest, CA (US); Peter Wahl, Ventura, CA (US); Stephen Steen, Carointeria, CA (US)

(73) Assignee: Clipper Windpower, LLC, Carpinteria, CA (US)

(21) Appl. No.: 13/266,604

(22) PCT Filed: Jul. 7, 2010
(86) PCT No.: PCT/IB10/01667

§ 371 Date: Jun. 4, 2012

Related U.S. Application Data
(60) Provisional application No. 61/270,600, filed on Jul. 9, 2009.
(60) Provisional application No. 61/340,597, filed on Mar. 19, 2010.

(51) Int. Cl. H02P 9/04

(52) U.S. Cl. 290/44

(57) ABSTRACT

A yaw-drive system for a wind turbine housed in a movable-in-yaw nacelle affixed atop a tower on a roller bearing. A round-look high-flux core material forms the stator of a circular linear yaw motor. The stator is affixed to the tower and is stationary. A plurality of magnets is affixed to the nacelle in proximity with the core material, such that as the stator is excited in quadrature the nacelle rotates on the roller bearings about a yaw pivot.

### BACKGROUND OF THE INVENTION

1. Field of the Invention

This invention relates to wind turbines and more particularly to wind turbines mounted on a support structure for motion about a yaw axis.

2. Description of the Prior Art

A wind turbine employs wind turbine electric-power generator units, which utilize the rotation force generated by wind force on a plurality of rotor blades. The blades drive generator units via a rotor shaft and gears. The generator units are controlled by adjusting the pitch angle of the rotor blades to keep generation of power corresponding with the energy of wind and the required generation power at the time of operation.

The generator units are enclosed within a nacelle, along with a transmission mechanism for transmitting the rotation of the main shaft to the generator units, and are supported for rotation in a horizontal plane on a tower.

To ensure that the horizontal-axis wind turbine is producing a maximum amount of electrical energy at all times, a yaw drive is used to keep the rotor blades facing into the wind as the wind direction changes. The wind turbine has a yaw error if the rotor is not aligned with the wind. A yaw error will result in a lower amount of the wind energy impinging upon the rotor area. The yaw angle is the angle between the nacelle's heading and a reference heading into the direction of the wind. In the wind turbine nacelle, a yaw control keeps the blades always toward the direction of wind to allow the wind force to act efficiently on the blades. Rotating the nacelle into the direction of wind does this. The wind turbine yaw control includes a yaw brake. The yaw-brake constrains the nacelle when wind is strong due to extreme wind conditions.

Present yaw drive systems use a mechanical drive to turn the turbine toward the wind direction. Yawing systems are usually provided with one or more drive units, each comprising a drive motor, possibly a geared motor, and a pinion which transfers torque directly from the drive motor to an output gear part, e.g. in the form of a toothed gear ring, and preferably by means of intermeshing teeth. The nacelle is mounted on a roller bearing or a gliding yaw bearing. The brake may be a hydraulic or electric brake which fixes the position of the nacelle when the re-orientation is completed in order to avoid wear and high fatigue loads on wind turbine components due to backlash. These systems encounter problems such as frozen motor shafts, multiple motor drives sharing power, complexity and low reliability due to the large amount of moving parts.

It is desirable to have a yaw drive system that does not exhibit these unsatisfactory characteristics.

### SUMMARY OF THE INVENTION

Briefly, the invention relates to a yaw-drive system for a wind turbine housed in a movable-in-yaw nacelle affixed atop a tower on a roller bearing. A round-loop high-flux core material forms the stator of a circular linear yaw motor. The stator is affixed either to the tower or the nacelle and is stationary. The stator has multiple conductive windings which can build up a magnetic travelling field. A motor rotor comprising a number of magnets is affixed either to the moveable nacelle or to the tower in proximity with the core material, such that as the stator windings are excited in quadrature the nacelle rotates on the roller bearings about a yaw pivot. Therefore, if the tower carries the windings, the magnets are mounted to the nacelle. On the other hand, if the magnets are affixed to the tower, the windings are mounted to the nacelle. In the latter case the control signals for the windings and power are readily available in the nacelle. Further they are environmentally safest on this side. Additionally, mounting the electronics on the nacelle allows them to be inside the nacelle where room can be made.

Moreover, mounting electronics and windings on the nacelle side eliminates relative motion between electronics/coils and nacelle systems, otherwise the electronics/coil connections must go through a slip ring or tower cable loop to get signal from nacelle. Any kind of linear motor can be implemented with the invention. Further, the stator and rotor can be made in two or more annular sections, in order to reduce the difficulty of mounting the motor. This also improves the serviceability.

The invention has the advantage that the linear motor allows for much reduced contact between the turbine yaw system and the tower, thus alleviating such problems as frozen motor shafts and multiple motor drives sharing power.

The invention has the advantage of reduced mechanical complexity, with higher reliability and has a minimum amount of moving parts.

The invention has the advantage that by a having linear motor that uses an electric drive, rather than a mechanical drive to turn the nacelle, a major source of potential problems is eliminated.

It is a further advantage of the invention to provide a wind turbine which has reduced Lifetime Cost of Ownership.

It is a further advantage of the invention that the yaw-drive system provides proportional control on the yaw motor and brake system to significantly reduce the cost of the yaw motor.

### BRIEF DESCRIPTION OF THE DRAWINGS

FIG. 1 is an exploded view in perspective showing a wind turbine in which this invention is embodied supported on a tower;

FIG. 2 is a top view of a quarter section of the stator 23 shown in FIG. 1;

FIG. 3A is a cross-sectional view of a first embodiment of the invention along the view lines 3-3 of FIG. 2;

FIG. 3B is a cross-sectional view of a second embodiment of the invention along the view lines 3-3 of FIG. 2;

FIG. 3C is a detail view of the first embodiment of the invention shown in FIG. 3A;

FIG. 3D is a detail view of the second embodiment of the invention shown in FIG. 3B;

FIG. 4 is a state diagram of a linear yaw motor electronic quadrature drive circuitry and yaw brake controls;

FIG. 5 is a heater control block diagram for a heater which can apply voltage to one or more of the yaw motor windings.

### DESCRIPTION OF THE PREFERRED EMBODIMENT

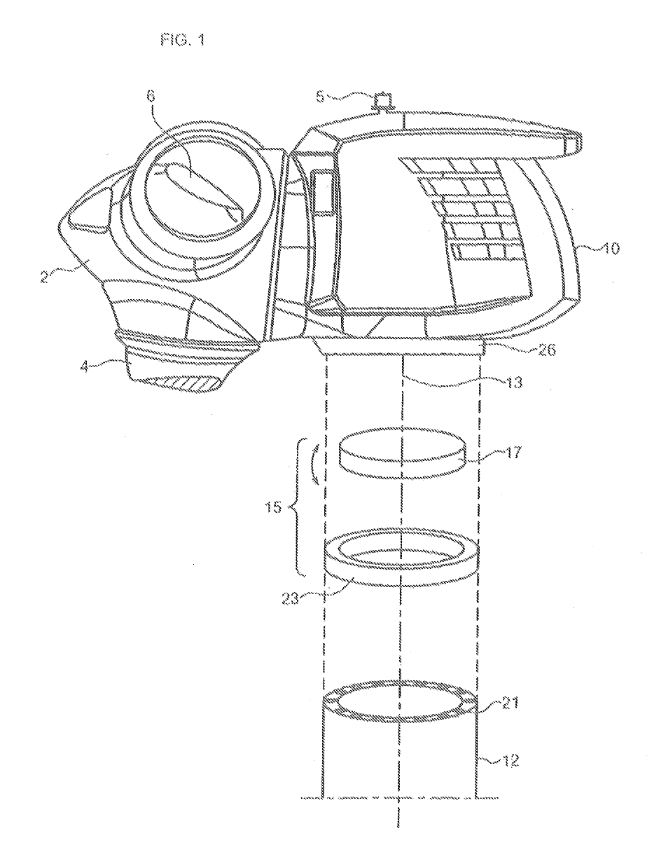

Refer to FIG. 1. A wind turbine includes a hub 2 to which rotor blades 4, 6 are attached. The hub 2 is attached to a main shaft, which drives gears and generators inside a nacelle 10. The nacelle 10 rests upon support tower 12, which is preferably a tower-like structure resting on the ground, on the bottom of the ocean or floating on the ocean. The wind turbine nacelle 10 is supported on the support structure 12 using ball bearings so as to be rotatable about a yaw axis 13 to be facing the wind direction as indicated by an anemometer 5, which is a device that measures both wind direction and wind speed. The turbine nacelle 10 rests upon a circular Neodymium Iron Boron permanent magnet linear yaw motor 15, which fits on the inside of the nacelle 10. The magnets may be permanent magnets or energized magnets.

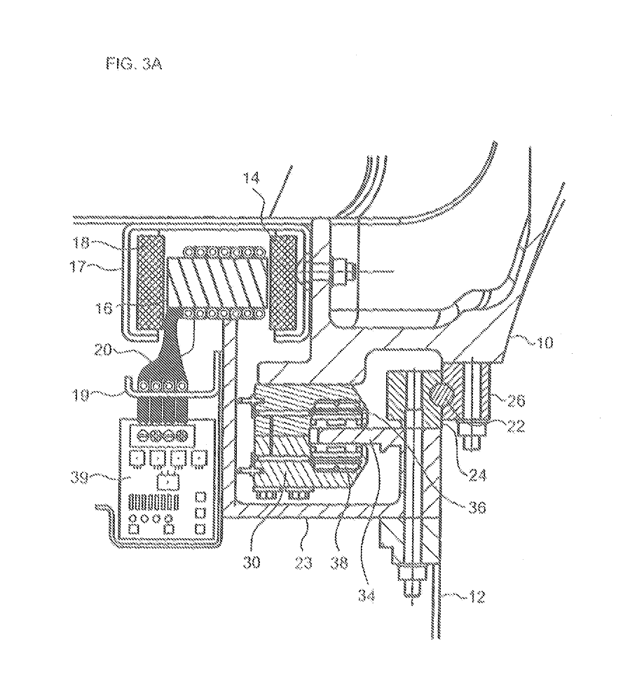

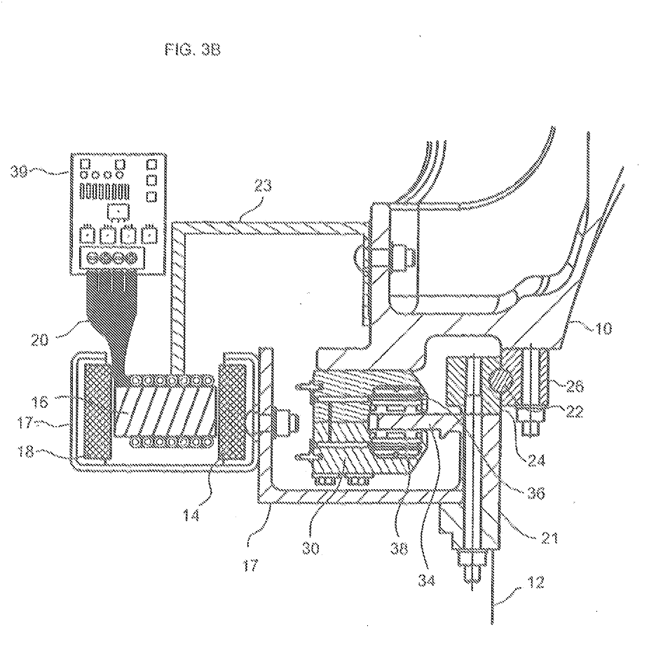

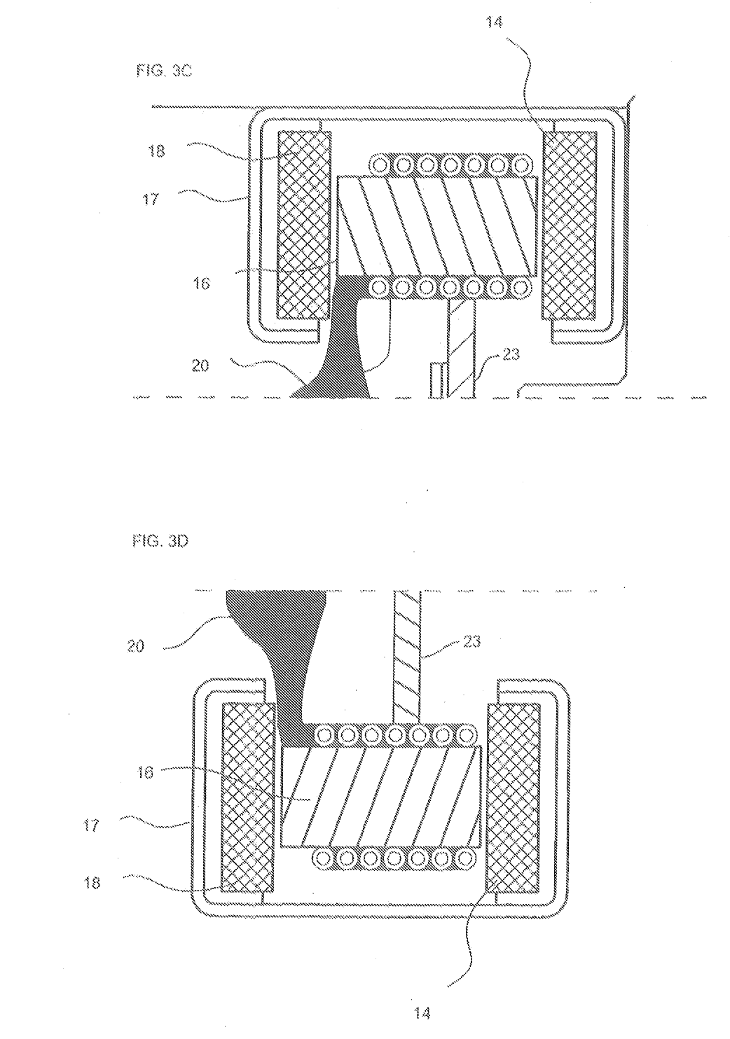

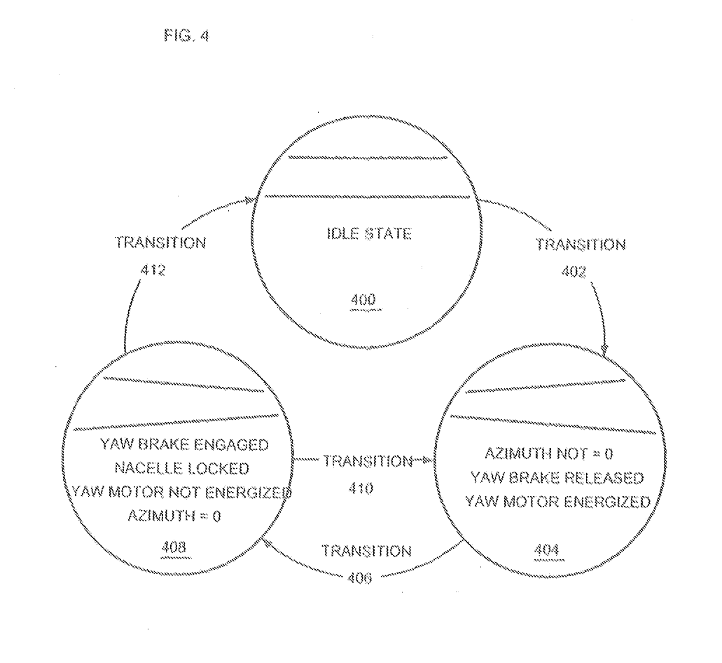

The yaw-drive system for the wind turbine is housed in the movable-in-yaw nacelle 10 affixed atop the tower 12. The permanent magnet linear yaw motor 15 comprises a core material 16 forming the stator 23 of a circular linear yaw motor located between the nacelle 10 and the tower 12. The core material 16 carries multiple conductive windings connected to a controlled power supply, and a plurality of magnets (shown in FIG. 3) in proximity with the core material.

An inverted U-shaped circular motor rotor comprises a number of magnets arranged around the inner surfaces (on each leg of the U) of the motor rotor, spaced so as to form an air gap between the magnets. This is described more fully below with reference to FIG. 3. The motor rotor 17 is bolted either to the moveable nacelle 10 (as shown in FIG. 1) or to the top of the tower flange 21. A round-loop high-flux core material forms the stator 23 of the circular linear yaw motor and is affixed opposite the rotor. The stator 23 is affixed either to the tower 12 and is stationary or to the nacelle in which case it rotates with the nacelle. In FIG. 1 and FIG. 3 the stator 23 is shown affixed to the tower and the rotor 17 affixed opposite the stator to the nacelle.

The magnets arranged around the inner circumference of the motor rotor 17 form an air gap between them. In FIG. 1 the motor rotor 17 is a shown affixed to the moveable nacelle such that the magnets are in proximity with the core material, which protrudes into the air gap. The stator 23 comprises multiple windings, which can be excited in order to establish a travelling magnetic field. As the stator 23 windings are excited in quadrature a linear force is produced in the magnets and the nacelle rotates on roller bearings about a yaw axis pivot 13.

In FIG. 1 the core material 16 forming the stator 23 of the circular linear yaw motor is affixed to a flange 23 atop the tower 12 and the plurality of magnets in the rotor 17 are affixed to the nacelle 10 in proximity with the core material 23.

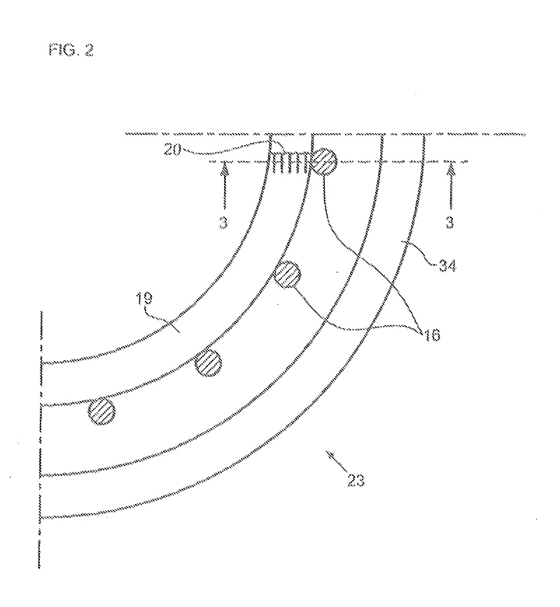

Refer to FIG. 2, which is a top view of a quarter section of the stator 23 shown in FIG. 1. The yaw motor electronic quadrature drive circuitry 39 (FIG. 3) is connected to two pairs of wires 20. One pair of wires is connected to the stator pole coils, which are wound around each pole 16 counterclockwise to drive the motor rotor first direction. The other pair of wires are connected to the stator pole coils and are wound around each pole 16 clockwise to drive the motor rotor in a reverse direction. A cable tray 19 may be necessary to contains the start and finish connections for the stator windings 20 and interface connections to the circular linear yaw motor electronic quadrature drive circuitry 39 (FIG. 3). A brake disk 34 is provided to allow braking the rotatable nacelle, described more fully below with reference to FIG. 3.

Refer to FIG. 3A, which is a cross-sectional view along the view lines 3-3 of FIG. 2. A linear motor (linear induction motor) is an alternating current (AC) electric motor that has had its stator “unrolled” so that instead of producing a torque (rotation of a shaft) it produces a linear force along its unrolled length. As shown in FIG. 1, for this invention the linear motor 15 is curved into a closed circle, so that it produces a linear force along the circumference of the circle. The motor is of the linear synchronous motor (LSM) design with an active winding placed within an air-gap and an array of alternate-pole magnets 14, 18 on opposite sides of the air gap. The magnets 14, 18 are permanent magnets, however energized magnets can be used as well.

A round-loop high-flux core material 23 forms the stator of the circular linear yaw motor. The Neodymium Iron Boron permanent magnets 14, 18 are part of the circular linear yaw motor upon which the top part of the wind turbine rotates. The permanent magnets 14, 18 are within inverted U-shaped circular motor rotor 17, which is bolted to the interior of the nacelle 10. A cable tray 19 contains the start and finish connections for the stator windings 20 and interface connections to the circular linear yaw motor electronic quadrature drive circuitry 39.

The yaw motor electronic quadrature drive circuitry 39 is connected to two pairs of wires 20. One pair of wires is connected to the stator pole coils, which are wound around each pole counterclockwise to drive the motor rotor first direction. The other pair of wires is connected to the stator pole coils and are wound around each pole clockwise to drive the motor rotor in a reverse direction.

Ball bearings 22, placed between an inner race 24 and outer race 26 provide a rolling-element bearing. The bearing uses balls to maintain the separation between the moving parts of the bearing. The ball bearing reduces rotational friction between the moving nacelle 10 and the tower 12. It achieves this by using at two races 24, 26 to contain the balls and transmit the loads through the balls. The inner race 24 is bolted to the tower 12 and the outer race 22 is bolted to the nacelle 10. As the outer race 26 rotates it causes the balls 22 to rotate as well. Because the balls are rolling they have a much lower coefficient of friction than if two flat surfaces rub on each other.

A brake disk 34 is attached between the support tower 12 and the bearing 24. A hydraulically actuated disk brake unit having a hydraulic cylinder and a brake caliper 36, 38 sandwiches the brake disk 34. Pressing the brake disk on its upper and lower side by the hydraulically actuated disk brake unit locks rotation of the wind turbine 10 relative to the support tower 12. When activated by electrical current the pads 36, 38 release the disc 34 and the nacelle 10 is free to rotate. The brake unit is described more fully in U.S. Provisional Application 61/211,833 filed Apr. 4, 2009 and International Application PCT/IB2009/006642. Briefly, the yaw brake apparatus referred to, comprises a circular rotation support base having an inner and outer cylinder wall, wherein the circular rotation support base is mounted directly on the top face of a wind turbine tower. The apparatus further comprises a nacelle mounted to the circular rotation support base, a plurality of brake lining elements, removably mounted to the circular rotation support base, and a disc brake unit acting upon the brake disc elements.

The apparatus is easily serviceable since the wear elements, i.e. the brake lining elements, are removably mounted to the circular rotation support base and can therefore be replaced or repaired without removing the rotation support base and the nacelle from the turbine tower. In case the brake lining elements need to be replaced they are simply disconnected from the rotation support base while the latter remains on the top face of the turbine tower, and the nacelle remains on the rotation support base.

Once a wind turbine is erected at a given place the wind direction at this place has a preferred direction and therefore the wear of the brake lining elements is not constant. By providing a plurality of brake lining elements it is possible to replace or repair only those elements which are worn out reducing the turbine downtime and maintenance costs significantly.

Certainly, other brake setups may be used with the invention. Particularly integrally formed brake disc may be used, which may be arranged between a support structure, i.e. the turbine tower and a rotation support base carrying the nacelle.

According to the invention the mechanical complexity of the system is reduced. Concerning the yaw drive, the setup has increased electrical complexity. However, this complexity, being electronic in nature does not incur the same reliability drawbacks as mechanical complexity. Overall the system according to the invention is much more reliable because the mechanical complexity of gearboxes, pinions, ring gears, etc., are eliminated.

The invention provides a wind turbine which has reduced Lifetime Cost of Ownership. In the yaw drive there are no gear wear items and no gearbox lubrication is required. Further, no side-thrusts on bearings due to gearbox pinion mesh preload occur. The stress on yaw bearings is reduced and thus reduced bearing service is required.

According to the invention there are no side thrusts due to pinion “walk out” in slew gear mesh, therefore less stress on yaw bearings and reduced bearing service is achieved.

No pinion/slew gear oiling system or maintenance is needed with the invention and no backlash impacts when changing direction occur. Therefore the inventions provides for reduced mechanical stresses and lowers cost for mechanical parts.

With the linear yaw drive according to the invention there are no “cogging” thrusts (etc.) of the pinion/slew gears exciting tower vibration or shock loading on mechanical parts.

In systems according to the state of the art wind turbines often stay in one place for longer than optimal periods due to the desire to reduce the start and stop impact from the contactor drive on the motor. In contrast the proportional brake and yaw according to the invention enable the system to, without consequence, slightly dither yaw angle without break/load impacts to reduce “false brinelling” of yaw bearing/race and help ball bearings refresh their lubrication.

Apart from the above given advantages, the Linear motor has significantly lower rotational inertia, as there is no inertia reflected through a very large yaw gearbox ratio (˜10 k:1). The setup is therefore much more agile than systems of the art.

At the same there is less impact loading: The linear motor method, because of lower inertia, can be made “compliant,” in that the position servo regulator can be made to have some “give” depending on load transients. This is a significant enabler of this design in that known yaw systems have such a large inertia that the yaw pinion is required to take all of the transient load force; the reflected gearbox inertia precludes the motor from reducing effective torque fast enough to soften impact loads.

The tower dynamics are also affected in a positive manner. The yaw drive according to the invention does not have gearbox inertia/elasticity issues, which can cause significant resonances with the tower/nacelle dynamics. The Motor/position servo has dynamic response to dynamically counteract (damp) torsional vibrations between nacelle/tower/rotor during yaw.

Finally, the yaw drive according to the invention is inherently much quieter because there are no high-speed moving components, no need for active cooling (very large air gap area per power ratio) and no intermeshing gears.

Therefore the yaw drive system according to the invention has various advantages over the known yaw drive systems. Particularly the combination of the drive and the brake systems as described has even more advantages.

Refer to FIG. 3B, which is a cross-sectional view of a second embodiment of the invention along the view lines 3-3 of FIG. 2.

A round-loop high-flux core material 23 forms the stator of the circular linear yaw motor. The permanent magnets 14, 18 are part of the circular linear yaw motor upon which the top part (nacelle) of the wind turbine rotates. The permanent magnets 14, 18 are within U-shaped circular motor rotor 17, which is bolted to the tower 12. The cable tray 19 of the first embodiment shown in FIG. 3A that contains the start and finish connections is eliminated as unnecessary in this second embodiment.

The yaw motor electronic quadrature drive circuitry 39 is located in the nacelle and is connected to two pairs of wires 20. One pair of wires is connected to the stator pole coils, which are wound around each pole counterclockwise to drive the motor rotor first direction. The other pair of wires is connected to the stator pole coils and are wound around each pole clockwise to drive the motor rotor in a reverse direction.

The motor rotor 17 is bolted to the top of the tower flange 21. A round-loop high-flux core material forms the stator 23 of the circular linear yaw motor and is affixed opposite the rotor. The stator 23 is affixed to the nacelle and it rotates with the nacelle.

It is preferable that the core material forming the stator 23 of the circular linear yaw motor be affixed to the nacelle 10 and the plurality of magnets in the rotor 17 be affixed to the tower 12 in proximity with the core material 23.

The advantages of this arrangement are as follows. The control signals and power are usually more readily available in the nacelle, not in the tower. They are also environmentally safest in the nacelle.

Mounting the electronics 39 on the nacelle side allows them to be inside the nacelle where there is usually more room available and more easily accessible. Putting the electronics on the tower side means a component tray, as shown under 39 in FIG. 3A should be provided.

Mounting electronics on nacelle side means no relative motion occurs between the electronics and coils and the nacelle systems. Otherwise the electronics/coil connections must go through a slip ring or tower cable loop to get signals from the nacelle.

Refer to FIG. 3C, which is a detail view of the first embodiment of the invention shown in FIG. 3A. A round-loop high-flux core material 16 forms the stator of the circular linear yaw motor, which is bolted to the nacelle. Permanent magnets 14, 18 are part of the circular linear yaw motor upon which the top part (nacelle) of the wind turbine rotates. The permanent magnets 14, 18 are within an inverted U-shaped circular motor rotor 17, which is bolted to the nacelle. The horizontal orientation of the core windings is such that the flux path is perpendicular to the air gap between the core and the permanent magnets 14, 18.

FIG. to 3D, which is a detail view of the second embodiment of the invention shown in FIG. 3B; A round-loop high-flux core material 16 forms the stator of the circular linear yaw motor, which is bolted to the nacelle. Permanent magnets 14, 18 are part of the circular linear yaw motor upon which the top part (nacelle) of the wind turbine rotates. The permanent magnets 14, 18 are within U-shaped circular motor rotor 17, which is bolted to the tower. The horizontal orientation of the core windings is such that the flux path is perpendicular to the air gap between the core and the permanent magnets 14, 18.

### Yaw Motor Electronic Quadrature Drive Circuitry

The yaw motor electronic quadrature drive circuitry 39 shown in FIG. 3 is connected to two pairs of wires 20. One pair of wires is connected to the stator pole coils, which are wound around each pole counterclockwise to drive the motor rotor first direction. The other pair of wires is connected to the stator pole coils and is wound around each pole clockwise to drive the motor rotor in a reverse direction.

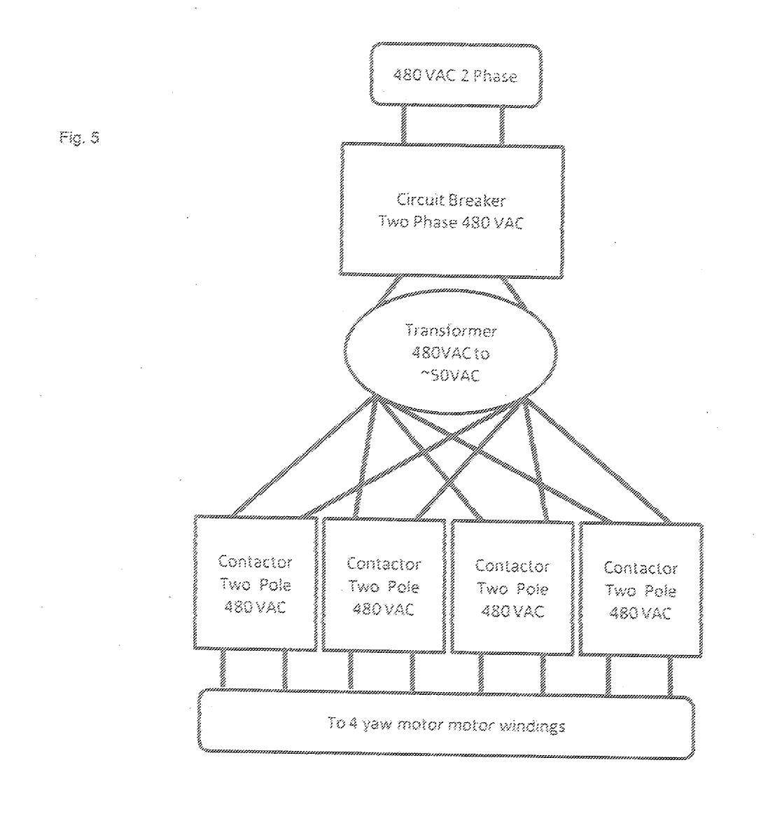

The yaw motor electronic quadrature drive circuitry 39 is a microprocessor programmed to carry out the control of the yaw motor and the yaw brake. This may be done by a programmable logic array (PLA), a programmable logic controller (PLC), an embedded microprocessor based controller, or any microprocessor or digital signal processor (DSP) device with programmable software used to implement combinational logic circuits to control a system. The PLA implements a state diagram shown in FIG. 4 for the system of the linear yaw motor electronic quadrature drive circuitry and the yaw brake controls.

In wind turbines, yaw control (azimuth control) is performed by releasing or applying a yaw brake and by activating or deactivating a yaw motor. In a wind turbine an azimuth is the angle from a reference vector (a point on the wind turbine tower) in a reference plane to a second vector (wind direction) in the same plane.

When the angle deviation between the wind direction detected by the wind direction detector 5 and the actual nacelle position relative to a point on the stationary tower is larger than a predetermined angle, the yaw brake 34, 36, 38 is released to allow the nacelle to rotate in a horizontal plane around the axis of rotation 13 to align itself with the wind direction. The yaw brake 34, 36, 38 is applied to hold the wind turbine such that the rotor blades are positioned in the direction of wind.

The yaw-drive system provides proportional control on the brake system to significantly reduce the cost of the yaw motor. When wind direction changes, the yaw brake 34, 36, 38 is released proportionally and the yaw motor is energized such that the nacelle is rotated toward a new position. As the new position is approached, the yaw brake 34, 36, 38 is applied proportionally and the yaw motor is de-energized. The wind turbine changes position smoothly thus reducing the forces acting on yaw mechanism.

### Method of Operation

Refer to FIG. 4, which is a state diagram of the control method of the invention, i.e. the interaction between the yaw motor drive and yaw brake controls. Three states, 400, 404, 408, are shown corresponding to the idle state, yaw azimuth angle error and yaw angle zero respectively. The idle state 400 corresponds to when the nacelle is locked in position, the yaw brake is on and the yaw motor is not energized. When the wind turbine is, activated, a transition (402) is made from state 400 to state 404 and the state transfers to state 404 wherein the yaw brake is gradually released as the yaw motor is gradually activated in a direction to reduce the yaw error to zero.
When the yaw error reaches a predetermined value, the yaw brake is gradually engaged and the yaw motor is gradually de-activated. When the yaw error reaches zero, the transition (406) is made from state 404 to state 408 and the state transfers to state 408. In the state 408 the nacelle is locked, the yaw motor is not energized, and the azimuth is zero (the nacelle is facing the wind).
If the wind speed is below cutout and the wind direction changes such that the yaw error is not zero, a transition (410) is made from state 408 to state 404 and the state transfers to state 404 wherein the yaw brake is gradually released and the yaw motor is activated in a forward or reverse direction to reduce the yaw error to zero. When the yaw error reaches a predetermined value, the yaw brake is gradually engaged and the yaw motor is gradually de-activated until the yaw error is reduced to zero. When the yaw error reaches zero a transition (406) is made from state 404 to state 408 and the state transfers to state 408. This loop between the two states 408 and 404 continues while the turbine is operational or the wind speed increases to above cutout where it must be shut down. When the wind speed is above cutout the state moves (412) to the idle state (400) and lock down of the nacelle occurs.

The stator is driven by multiple, timed quadrature signals, which are generated from a lookup table and then processed by low-level drive and power semiconductor circuitry usually in the form of a full bridge circuit configuration for each drive line. In this manner, each bridge drive can control not only stator power in terms of timing, but also whichever direction is required as well.

According to the invention, alternative configurations of magnets in relation to the stator are possible. Particularly, the stator coil may be sandwiched between two magnets. Therefore, various motor orientations are possible depending on where the air gap of the motor is placed—12 o'clock, 3 o'clock, 6 o'clock, or 9 o'clock.

Further, alternative configurations of magnets in relation to the stator are possible, wherein two magnets are sandwiched between the stator coils.

As can be seen, the invention may be implemented with various designs for linear motors. Particularly, three-phase linear motors may be used or the stator may be secured to the nacelle whereas the magnets are secured to the tower.

The invention is also usable as a combined drive and heating system for yaw drives. In typical climates and conditions in which wind turbines are used, humid air contacting a cold yaw drive causes condensation that can lead to accelerated deterioration of yaw drive parts. Condensation does usually not exist while the motor is running because the heat generated by the motor keeps the motor dry. However, when the motor is shut down, condensation starts to form; the longer the idle period, the more pronounced the rate of deterioration.

According to the invention some or all of the motor windings are used as the heating element for the yaw drive. A low voltage input to one or more motor windings is applied to produce the heat needed to keep the yaw motor within the rated temperature as well as provide a temperature delta to keep condensation off the motor for corrosion protection. Certainly the heating voltage may be applied when the yaw brake is engaged. The voltage may further be a DC voltage or AC voltage. For this purpose the existing circuitry may be used or some or all of the windings may be connected with additional circuitry. This approach is advantageous because the windings of the linear motor are in good thermal contact with the parts of the assembly which do move relative to each other during yaw alignment. That is due to the structural difference between a conventional mechanical yaw drive and a circular linear motor drive. The combination of the use of a circular linear motor and the motor windings as heating elements does save costs and requires fewer parts to achieve a reliable yaw drive system.

Refer to FIG. 5. A 480 VAC, 2 phase voltage supply is connected with the one or more of the 4 yaw motor windings 20 though a two phase circuit breaker and a 480 VAC to 50 VAC transformer. The yaw motor electronic quadrature drive circuitry 39 includes circuitry, which causes the voltage supply to regulate the supplied voltage dependent on the temperature of the circular linear yaw motor.

1. A yaw-drive system for a wind turbine housed in a movable-in-yaw nacelle affixed atop a tower comprising:
a core material forming the stator of a circular linear yaw motor located between said nacelle and said tower;
said core material carrying multiple conductive windings connected to a controlled power supply; and
a plurality of magnets in proximity with said core material.

2. The yaw-drive system of claim 1, wherein said a core material forming the stator of a circular linear yaw motor is affixed to said nacelle; and
said plurality of magnets are affixed to said tower in proximity with said core material.

3. The yaw-drive system of claim 1, wherein said a core material forming the stator of a circular linear yaw motor is affixed to said tower; and
said plurality of magnets are affixed to said nacelle 10 in proximity with said core material.

4. The yaw-drive system of claim 1, wherein said magnets are permanent magnets or energized magnets.

5. The yaw-drive system of claim 1, wherein said nacelle is affixed atop said tower on roller bearings such that as said stator is excited in quadrature said nacelle rotates on said roller bearings about a yaw pivot.

6. The yaw-drive system of claim 1, including a yaw brake and a proportional control on said yaw brake.

7. The yaw-drive system of claim 1, wherein one or more of the motor windings of the circular linear yaw motor are connected for being supplied with a heating voltage in order to keep the circular linear yaw motor above a given temperature.

8. The yaw-drive system of claim 7, wherein a voltage supply is connected with the one or more of the motor windings and wherein the voltage supply regulates the supplied voltage dependent on the temperature of the circular linear yaw motor.
